(19) United States
(12) Patent Application Publication
(10) Pub. No.: US 2025/0018554 A1
(43) Pub. Date: Jan. 16, 2025

(54) WEARABLE SUIT

(71) Applicant: WITHFORCE Inc., Uiwang-si (KR)

(72) Inventors: Youngmin KIM, Osan-si (KR); Laehoon JEONG, Suwon-si (KR)

(73) Assignee: WITHFORCE Inc., Uiwang-si (KR)

(21) Appl. No.: 18/650,814

(22) Filed: Apr. 30, 2024

(30) Foreign Application Priority Data
Jul. 14, 2023 (KR) 10-2023-0091808

(51) Int. Cl. B25J 9/00; A61H 3/00

(52) U.S. Cl. CPC B25J 9/0006; A61H 3/00; B25J 9/0009; A61H 2003/007

(57) ABSTRACT

Provided is a wearable suit. The wearable suit includes: a device part provided with springs made of shape memory alloy; shoulder straps coupled to allow a wearer to shoulder the device part; an abdominal fixation part configured to allow the device part to be worn on the wearer's abdomen; and lower extremity belts coupled to a wire exposed from the device part. The springs assist in pulling out the wire exposed from the device part by contracting and expanding in response to supplied power. The device part may include an upper terminal configured therein. A first wire may be configured to extend from the upper terminal. The other end of the first wire may be coupled to a support member. First ends of the plurality of springs made of shape memory alloy may be arranged on the other side of the upper terminal.

### CROSS-REFERENCE TO RELATED APPLICATION

This application claims the benefit of Korean Patent Application No. 10-2023-0091808 filed on Jul. 14, 2023, which is hereby incorporated by reference herein in its entirety.

### BACKGROUND

### 1. Technical Field

The present invention relates to a wearable suit.

More particularly, the present invention relates to a wearable suit in which a plurality of springs made of shape memory alloy are provided in order to overcome problems such as increased manufacturing cost and heaviness of conventional ones using a separate power means such as a motor or actuator, so that assisting force is provided to a wearer who wears the wearable suit.

In addition, the present invention relates to a wearable suit in which individual components constituting the wearable suit are modularized, so that the attachment and detachment of the individual components for repair and maintenance is facilitated.

### 2. Description of the Related Art

A wearable robot or wearable suit refers to a mechanical device that is worn on the human body and performs a function.

Such wearable suits are functionally equipped with artificial intelligence (AI) to provide processing capabilities that humans cannot perform, or structurally assist with human movement or the generation of muscle strength.

In addition, as technology develops, the functionality of wearable suits is diversified by combination with various technologies. For example, due to advances in sensor, control, and software technology, wearable suits are being used in various fields such as the military, disaster relief, industrial work, rehabilitation treatment, and daily assistance fields.

In particular, wearable suits assist with a wearer's physical abilities in physically demanding environments such as disaster sites or mountainous terrain, thereby increasing a human work performance range as well as human work performance time.

Furthermore, wearable suits provide a great deal of help in modern life by assisting with a wearer's muscle strength in daily life or helping to overcome problems related to physical defects.

These wearable suits may be classified into passive type and active type according to the method of implementing power in the wearable suit.

The passive type refers to a method that uses a preset force such as the force of a spring or elastic band, and the active type refers to a method that uses a changeable force such as the force of a motor or actuator.

Since the active type uses heavy equipment, it naturally has a significant heavy weight, so that it has significant limitations in movement and requires considerably high manufacturing cost.

In contrast, the passive type has the advantage of being considerably lighter and cheaper when an elastic band is used, but it is difficult to use the passive type for muscle strength assistance because it only uses the accumulation and release of force.

In addition, among various passive types, a passive type using springs is mainly used for the purpose of fixing posture. Since it is still used for the purpose of fixing posture, it forms an exoskeleton and has significant limitations in movement.

FIG. 7 shows an example of using the passive type using springs among the conventional passive types.

The present applicant would like to propose a wearable suit that can assist a wearer's muscle strength when the spring type is applied. This type of wearable suit overcomes the disadvantages of limitations in movement while making use of the advantages of being light and inexpensive of the spring type.

As a related technology, Korean Patent Application Publication No. 10-2022-0053349 discloses a wearable muscle strength assistance device.

This technology is directed to a wearable muscle strength assistance device that can be worn as an exoskeleton type to assist with muscle strength. The wearable muscle strength assistance device includes: wearable equipment including an upper unit configured to come into contact with a wearer's upper body and a lower unit configured to come into contact with the wearer's lower extremities; and a mounting part configured to be selectively connected and detachably coupled to one side of the upper unit, to extend in one direction to enable the mounting of an article, and to allow at least a portion thereof to extend upward when coupled to the upper unit. The upper unit includes a base frame and an elastic cylinder coupled to the base frame. The lower unit includes a support coupled to the upper unit, a first frame extending from the support, a second frame extending along the extension line of the first frame, and joints connected to the first and second frames and configured to enable elastic rotation between the first frame and the second frame. The joints are connected to one end of the wire, and the elastic cylinder is connected to the other end of the wire. When the upper unit and the lower unit are standing vertically, the more some of them are bent and/or curved, the more the elastic restoring force that restores the wire to its upright position is transmitted from the elastic cylinder to the wire, thereby increasing the tension of the wire.

However, the above technology cannot prevent limitations in movement described above because the device forms an exoskeleton, and the problem of an increased weight occurs because the actuator is used.

As another technology, Korean Patent No. 10-2388069 discloses wearable robot module for muscle strength assistance for each region using a cloth-type flexible actuator and a wearable robot including the same.

The technology is directed to a wearable robot module for muscle strength assistance. The wearable robot module for muscle strength assistance includes: an intention recognition unit configured to determine the intention of a wearer's movement; a control unit configured to generate a drive control signal for a drive unit based on a signal from the intention recognition unit; and a flexible drive unit configured to generate driving force for muscle strength assistance in response to a drive control signal from the control unit. The flexible drive unit includes: a waist fastener and leg fasteners configured to be fastened to the waist and legs of the wearer; and a plurality of connection members connected to the waist fastener and the leg fasteners and configured to transmit driving force. The cloth-type flexible actuator is configured to be installed at a portion corresponding to muscles that perform an extension motion between the waist fastener and the leg fasteners and generate driving force.

The above technology is a technology that uses springs to assist with muscle strength, but the use of springs is achieved by sewing the springs into fibers in bundles, which is different from what is intended in the present invention.

### SUMMARY

An object of the present invention is to provide a wearable suit in which a plurality of springs made of shape memory alloy are provided in order to overcome problems such as increased manufacturing cost and heaviness of the conventional ones using a separate power means such as a motor or actuator, so that assisting force is provided to a wearer who wears the wearable suit.

In order to accomplish the above object, the present invention provides a wearable suit including: a device part provided with springs made of shape memory alloy; shoulder straps coupled to allow a wearer to shoulder the device part; an abdominal fixation part configured to allow the device part to be worn on the wearer's abdomen; and lower extremity belts coupled to a wire exposed from the device part; wherein the springs assist in pulling out the wire exposed from the device part connected to the lower extremity belts by contracting and expanding in response to supplied power.

The wire exposed from the device part may be guided through a wire guide provided on one side of the device part.

One end of the wire exposed from the device part may be coupled to a connection part; the connection part may be configured to be rotatable; and a connection strap connected to the lower extremity belts is coupled to the connection part.

The one connection strap may be coupled to the connection part; and the connection strap may be wrapped around the connection part and then moved back again, so that both ends of the connection strap are coupled to the two lower extremity belts, respectively.

The two lower extremity belts may assist with the movement of one lower extremity belt and the other lower extremity belt due to the form in which the connection strap is coupled to the connection part.

The device part may include an upper terminal configured therein; a first wire may be configured to extend from the upper terminal; the other end of the first wire may be coupled to a support member formed on the other side of the device part; first ends of the plurality of springs made of shape memory alloy may be arranged on the other side of the upper terminal; and the other of the springs may be coupled to one side of a movable member provided between the upper terminal and a support member.

The first wire may be passed through the movable member, so that the movable member is guided by the first wire when it is moved in the vertical direction by the contraction and expansion of the springs.

A second wire may extend downward from the other side of the movable member; and the second wire may be passed through the support member and exposed to the wire guide.

The device part may be selectively opened and closed by a door; and, when the door is opened, the internal components of the device part may be removable.

The internal components of the device part may be connected by electric wires.

In accordance with the wearable suit according to the present invention configured as described above, the plurality of springs made of shape memory alloy are provided, so that assisting force is provided to a wearer who wears the wearable suit. Accordingly, the present invention has the advantage of overcoming problems such as increased manufacturing cost and heaviness of the conventional ones using a separate power means such as a motor or actuator.

### BRIEF DESCRIPTION OF THE DRAWINGS

The above and other objects, features, and advantages of the present invention will be more clearly understood from the following detailed description taken in conjunction with the accompanying drawings, in which:

FIG. 1 shows a wearable suit according to the present invention;

FIG. 2A and FIG. 2B, respectively, show the device part of the wearable suit according to the present invention;

FIG. 3 shows an example of separating the device part of the wearable suit according to the present invention from a lateral direction;

FIGS. 4 and 5 show an example of wearing and using the wearable suit according to the present invention;

FIG. 6 illustrates a connector for connecting the electric wires of the wearable suit according to the present invention; and

FIG. 7 shows an example of using the passive type using springs among the conventional passive types.

### DETAILED DESCRIPTION

The terms and words used in this specification and claims should not be construed as limited to their ordinary or dictionary meanings. Based on the principle that the inventor can appropriately define the concepts of one or more terms in order to describe his or her invention in the best way, the terms and words used herein should be interpreted to have meanings and concepts consistent with the technical spirit of the present invention.

Accordingly, the embodiments described in the present specification and the configurations shown in the drawings are only exemplary embodiments of the present invention and do not represent the overall technical spirit of the present invention. Therefore, it should be understood that at the time when the present application is filed, there may be various equivalents and modifications that can replace the embodiments and the configurations.

Prior to a description that will be given with reference to the accompanying drawings, it is noted that items that are not necessary to reveal the gist of the present invention, i.e., known configurations that can be easily added by a person skilled in the art, are not shown or described in detail.

The present invention is directed to a wearable suit.

More specifically, the present invention is directed to a wearable suit in which a plurality of springs made of shape memory alloy are provided in order to overcome problems such as increased manufacturing cost and heaviness of the conventional ones using a separate power means such as a motor or actuator, so that assisting force is provided to a wearer who wears the wearable suit.

In the following description of the present invention, when components of the present invention are described, terms such as first, second, A, B, (a), (b), etc. may be used. This is intended only to distinguish a component from other components, and the essence, sequence, and/or sequential position of the component are not limited by the terms.

Furthermore, when a component is described as being ‘connected,’ ‘coupled,’ or ‘joined’ to another component, the former component may be directly connected, coupled, or joined to the other component. However, it should also be understood that they may be ‘connected,’ ‘combined,’ or ‘joined’ to each other with a third component interposed therebetween.

Furthermore, when a part is described as ‘including’ or ‘having’ a component, it should be understood that, unless specifically stated to the contrary, the part does not exclude one or more other components, but the part may further include one or more other components or all components that are obvious to those skilled in the art.

Additionally, terms such as ‘part,’ ‘module,’ and ‘unit’ used herein refer to a unit that processes at least one function or operation, and may be implemented as hardware, software, or a combination thereof.

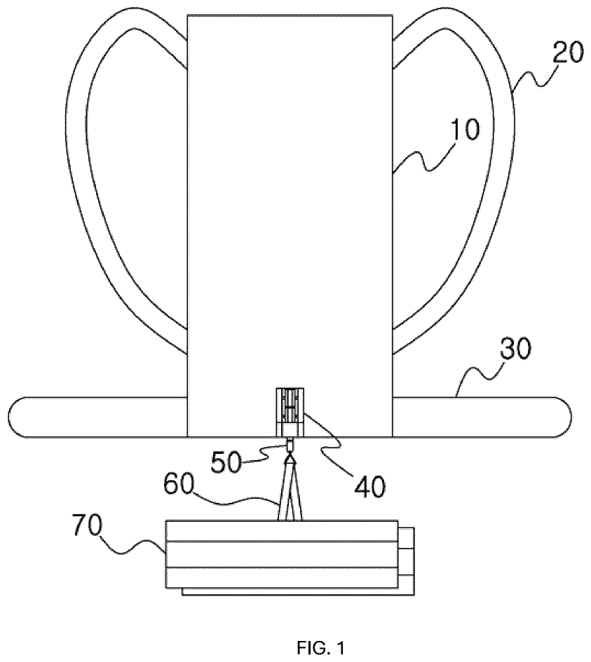

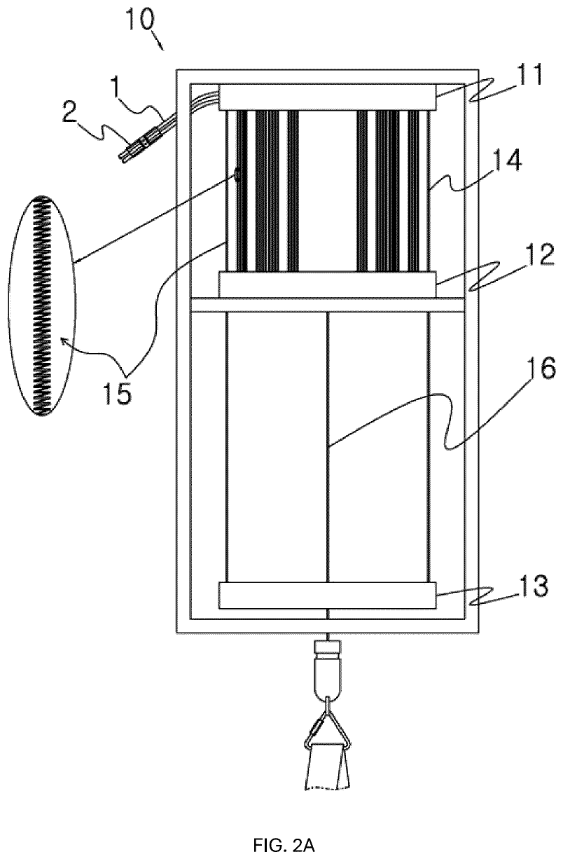

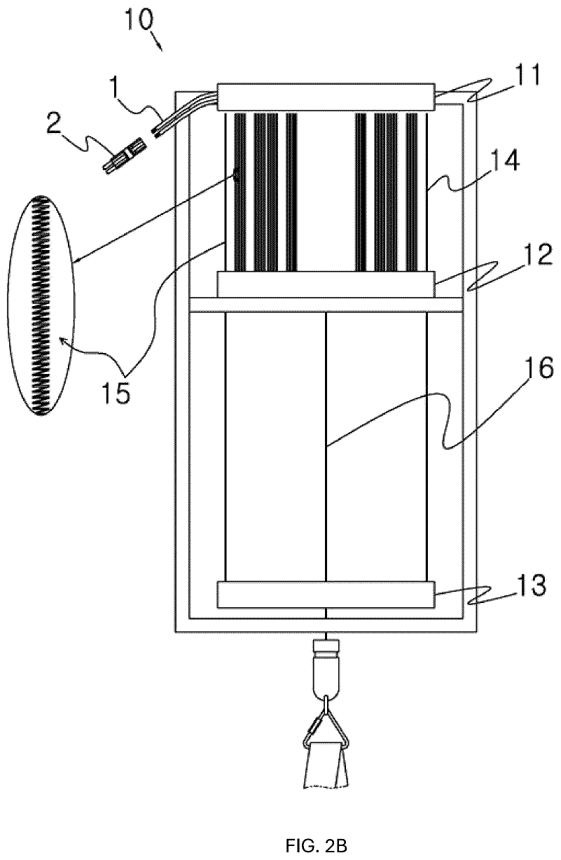

FIG. 1 shows a wearable suit according to the present invention, and FIGS. 2A and 2B show the device part of the wearable suit according to the present invention.

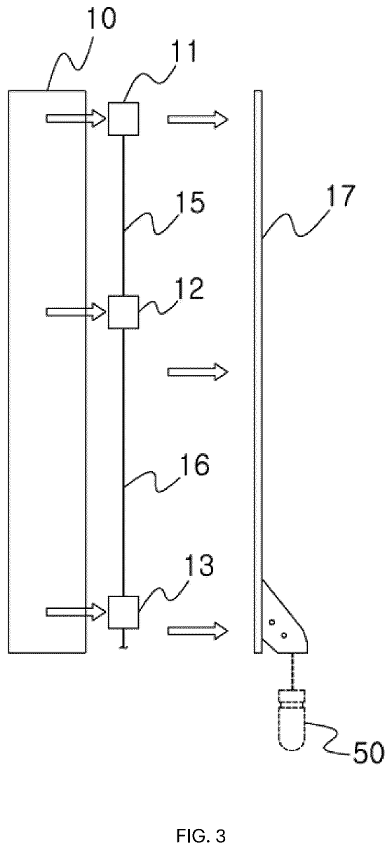

Furthermore, FIG. 3 shows an example of separating the device part of the wearable suit according to the present invention from a lateral direction.

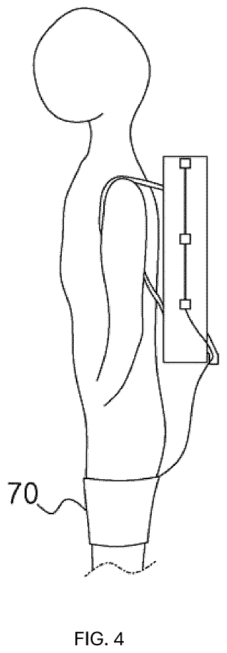

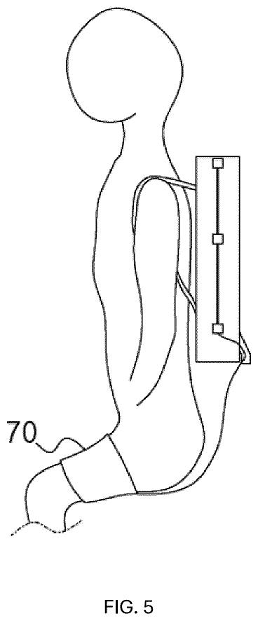

Finally, FIGS. 4 and 5 show an example of wearing and using the wearable suit according to the present invention.

The wearable suit of the present invention shown in FIG. 1 of the accompanying drawings includes a device part 10 configured to be worn on a wearer's back; shoulder straps 20 coupled to one side in order to allow the wearer to shoulder the device part 10; and an abdominal fixation part 30 configured to be worn on the wearer's abdomen for the stable fixation of the device part 10.

In this case, the shoulder straps 20 may be composed of a pair of straps like those of a normal bag to facilitate the wearer's wearing of the device part 10, but are not necessarily limited to this case. Any structure may be easily constructed by a person skilled in the art as long as the structure can carry the device part 10.

In addition, the abdominal fixation part 30 may be configured in the form of two belt segments extending in both directions of the device part 10, respectively, and may be wrapped around the wearer's abdomen and then fastened at its two opposite ends. In this case, the two opposite ends may be coupled to each other using regular Velcro tape, or a regular buckle or button, or any other coupling configuration may be employed.

In addition, the wearable suit according to the present invention may further include a wire guide 40 protruding from one side of the device part 10.

The wire guide 40 is a means that assists a wire, exposed from the device part 10, to be guided outside the device part 10. The wire guide 40 includes a hollow therein and is provided with at least one roller in the hollow, as shown in FIGS. 1 and 3 of the accompanying drawings, thereby guiding the wire exposed in the device part 10. In this case, it may be advantageous for the wire guide to use a butterfly roller as the roller for the wire guide.

As can be seen in FIG. 3 of the accompanying drawings, the wire guide 40 may be configured to have a somewhat inclined direction on one side of the device part 10, but the guided wire may be configured to protrude at least downward or forward from the device part 10. To this end, the wire guide 40 may allow a hole at an end thereof through which a wire passes to be formed on the bottom or front side (toward the wearer).

The reason why the configuration is made such that a wire is directed at least downward as described above is to ensure a smooth direction of force when assisting with the wearer's muscular strength. Furthermore, when the upper body is raised, the direction of force is distributed such that backward pulling force can be assisted more than downward pulling force.

As described above, a connection part 50 is coupled to the end of the wire having passed through the wire guide 40, and the connection part 50 allows a triangular holder using a ring to be coupled thereto.

In this case, the reason why the triangular holder is coupled using a ring is to facilitate rotation, which not only prevents the twisting of the wire, but also reduces discomfort when the wearer's legs are used.

In addition, a connection strap 60 is coupled to the triangular holder of the connection part 50. In this case, the connection strap 60 has a coupling method by which one strap is passed through the triangular holder and then moved back again. Accordingly, both ends of the connection strap 60 are directed downward. Lower extremity belts 70 to be fastened onto the wearer's lower extremities are coupled to respective ends of the connection strap 60.

Like the abdominal fixation part 30 described above, the lower extremity belts 70 are fastened onto the wearer's legs using various fastening means such as Velcro tape, buckles, and buttons.

In this case, the two lower extremity belts 70 are coupled to respective ends of the single connection strap 60 described above, so that the connection strap 60 can move freely on the triangular holder of the connection part 50, with the result that the legs of the wearer wearing the lower extremity belts 70 are made more comfortable.

Inside the device part 10, springs are provided to assist with the wearer's muscle strength, and the springs are made of shape memory alloy.

In addition, the material of the springs is shape memory alloy that can contract and expand, and is electrically connected by being coupled through a terminal. In this case, the wire may be pulled out from the device part 10 by the shape memory alloy that contracts and expands in response to electrical connection.

Using the springs made of shape memory alloy described above not only reduces weight but also reduces noise compared to the case of using a separate driving means such as a motor.

As described above, the springs of the present invention are springs made of shape memory alloy that contracts and expands in response to the reception of power. Heat is generated by the electrical resistance of the springs to applied power, and the springs made of shape memory alloy contract as the temperature increases. Additionally, as the supply of power is cut off, they cool and expand again.

As for the internal configuration of the device part 10 along with an additional description of the springs, first, an upper terminal 11 is formed inside the device part 10, and electric wires 1 for the supply of power are connected to the upper terminal 11.

Although not shown in the drawings, the electric wires 1 are connected to a power supply source provided inside or outside the device part 10 and perform the function of supplying power.

Furthermore, the upper terminal 11 is provided with a first wire 14 extending in the vertical direction of the device part 10, a support member 13 is coupled to the other end of the first wire 14, and the support member 13 is coupled to one side of the inside of the device part 10.

Furthermore, a plurality of springs 15 are arranged on the other side of the upper terminal 11. In this case, the second ends of the springs 15 are coupled to a movable member 12.

The movable member 12 is provided such that the first wire 14 passes therethrough.

In this case, the first wire 14 is composed of two segments between the upper terminal 11 and the support member 13 and functions to assist the movable member 12 with the up/down movement thereof.

Furthermore, a second wire 16 is connected from the movable member 12 to the support member 13 through the central area. In this case, the second wire 16 is coupled to the movable member 12, and passes through the support member 13, and is exposed out of the device part 10. In this case, the wire guide 40 described above guides the exposed second wire 16.

In other words, when the movable member 12 that moves in the vertical direction along the first wire 14 in response to the contraction and expansion of the springs 15 moves, the length by which the other end of the second wire 16 coupled to the movable member 12 is drawn out of the device part 10 may vary.

Due to the load applied when the movable member 12 is moved by the contraction and expansion of the springs 15 made of shape memory alloy, there is generated the force that can assist with the muscular strength for the movement of the lower extremities of the wearer who wears the lower extremity belts 70 coupled through the second wire 16.

One feature of the present invention is to facilitate the easy replacement of the internal components of the device part 10 described above.

For example, when the spring or terminal fails and needs to be replaced, it may be easily replaced due to its modularized configuration. As for the modularization in detail, the configuration is made such that the springs 15 can be detached from the terminal 11 and the movable member 12 and the wires 14 and 16 can also be detached from the upper terminal 11, the movable member 12, and the support member 13. Accordingly, one side of the device part 10 is selectively opened and closed using a door 17, and, when the door 17 is opened as shown in FIG. 3 of the accompanying drawings, the components may be separated through detachment.

In this case, in the case of the upper terminal 11, it is connected to a power supply source through the electric wires 1 as described above, so that for the purpose of easy separation, first sides of the electric wires 1 are separated and connected to the connector 2.

Although this is described through the upper terminal 11, this is intended only for the easy understanding of the present invention. In fact, this may be employed in all the configurations of the present invention that employ wired connections such as the electric wires 1 as well as the upper terminal 11.

By being connected through the connector 2, the wired connections for the components connected by the electric wires 1 via wired connections may be separated, which provides the advantage of enabling detachment for repair and maintenance.

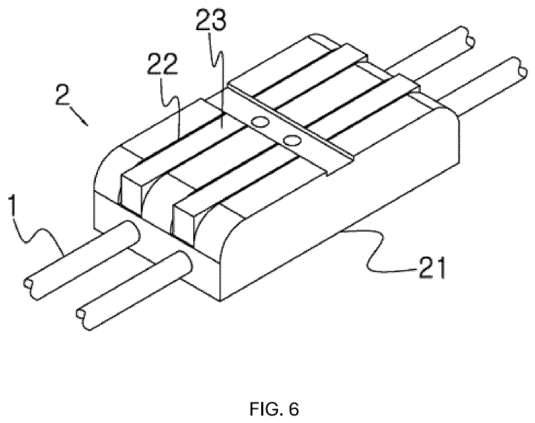

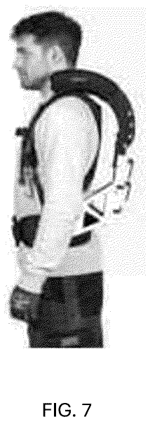

The connector 2 will be described in detail with reference to FIG. 6 of the accompanying drawings.

FIG. 6 illustrates the connector for connecting the electric wires of the wearable suit according to the present invention.

The connector 2 shown in FIG. 6 of the accompanying drawings includes: a body 21 including holes configured to couple the electric wires 1; grooves 22 formed at positions corresponding to the electric wires 1 on the upper side of the body 21; and connection terminal buttons 23 fitted into the grooves 22.

Each of the number of grooves 22 and the number of connection terminal buttons 23 may be formed to be equal to the number of wires 1 to be coupled. The connection terminal buttons 23 have an inverted and reversed ‘L’ shape, and are fitted into additional grooves (not shown in the drawings) formed by further extending lower protruding areas downward of the grooves 22.

In this case, the connection terminal buttons 23 may be rotated in the grooves 22 using hinges on first sides as axes. When rotated and positioned as shown in FIG. 6 of the accompanying drawings, the additional grooves are opened to enable connections between the electric wires 1 coupled in both directions. When the connection terminal buttons 23 are exposed from the grooves 22, the connections of the wires 1 in both directions facing the protruding areas located downward of the connection terminal button 22 are blocked.

In addition, the wires 1 whose electric connections are cut off may be pulled out and detached from the body 21, thereby facilitating the attachment and detachment of the components inside the device part 10 connected to the wires 1. This is shown in FIG. 2B of the accompanying drawings.

In accordance with the wearable suit according to the present invention configured as described above, the plurality of springs made of shape memory alloy are provided, so that assisting force is provided to a wearer who wears the wearable suit. Accordingly, the present invention has the advantage of overcoming problems such as increased manufacturing cost and heaviness of the conventional ones using a separate power means such as a motor or actuator.

The above description using the drawings is intended to describe only main features of the present invention. Since various designs may be made within the range of the technical spirit, it is obvious that the present invention is not limited to the configurations of the drawings.

What is claimed is:

1. A wearable suit comprising:
a device part provided with springs made of shape memory alloy;
shoulder straps coupled to allow a wearer to shoulder the device part;
an abdominal fixation part configured to allow the device part to be worn on the wearer's abdomen; and
lower extremity belts coupled to a wire exposed from the device part;
wherein the springs assist in pulling out the wire exposed from the device part connected to the lower extremity belts by contracting and expanding in response to supplied power;
wherein the device part includes an upper terminal configured therein;
wherein a first wire is configured to extend from the upper terminal;
wherein a remaining end of the first wire is coupled to a support member formed on a remaining side of the device part;
wherein first ends of the plurality of springs made of shape memory alloy are arranged on a remaining side of the upper terminal; and
wherein remaining ends of the springs are coupled to one side of a movable member provided between the upper terminal and a support member.

2. The wearable suit of claim 1, wherein the wire exposed from the device part is guided through a wire guide provided on one side of the device part.

3. The wearable suit of claim 2, wherein:
one end of the wire exposed from the device part is coupled to a connection part;
the connection part is configured to be rotatable; and
a connection strap connected to the lower extremity belts is coupled to the connection part.

4. The wearable suit of claim 3, wherein:
the one connection strap is coupled to the connection part; and
the connection strap is wrapped around the connection part and then moved back again, so that both ends of the connection strap are coupled to the two lower extremity belts, respectively.

5. The wearable suit of claim 4, wherein the two lower extremity belts assist with movement of one lower extremity belt and a remaining lower extremity belt due to a form in which the connection strap is coupled to the connection part.

6. The wearable suit of claim 1, wherein the first wire is passed through the movable member, so that the movable member is guided by the first wire when it is moved in a vertical direction by contraction and expansion of the springs.

7. The wearable suit of claim 1, wherein:
a second wire extends downward from a remaining side of the movable member; and
the second wire is passed through the support member and exposed to the wire guide.

8. The wearable suit of claim 1, wherein:
the device part is selectively opened and closed by a door; and
when the door is opened, internal components of the device part are removable.

9. The wearable suit of claim 8, wherein the internal components of the device part are connected by electric wires.
